(19) United States
(12) Patent Application Publication
(10) Pub. No.: US 2009/0220643 A1
(43) Pub. Date: Sep. 3, 2009

(54) METHOD OF PRODUCING BREAD

(75) Inventor: Hironobu KATO, Aichi (JP)

Correspondence Address: BUCHANAN, INGERSOLL & ROONEY PC, POST OFFICE BOX 1404, ALEXANDRIA, VA, 22313-1404, US

(73) Assignee: SHIKISHIMA BAKING COMPANY, LTD., Aichi (JP)

(21) Appl. No.: 12/039,229

(22) Filed: Feb. 28, 2008

(51) Int. Cl. A21D 2/08; A21D 8/02

(52) U.S. Cl. 426/19; 426/549

(57) ABSTRACT

A method of producing bread includes a step of preparing an intermediate dough material comprising wheat flour, 0.1 to 20 parts by weight of rice flour to 100 parts by weight of the wheat flour, salt and free of skimmed powdered milk, a step of adding 80 to 120 parts by weight of hot water to 100 parts by weight of the wheat flour to the intermediate dough material, a step of kneading the intermediate dough material added the hot water, a step of cooling an intermediate dough prepared by kneading until an internal temperature thereof becomes −5 degree C. to 10 degree C. and storing the intermediate dough for 24 to 72 hours with the internal temperature thereof kept in the temperature region; and a step of adjusting a temperature of the intermediate dough cooled in the cooling/storing step to 13 degree C. to 30 degree C., and wherein the intermediate dough whose temperature is adjusted to the temperature range in the temperature-adjusting step is utilized as a part of an end dough of the bread.

### BACKGROUND OF THE INVENTION

The present invention relates to a method of producing bread and more particularly to a method of producing bread having a characteristic in its texture and flavor.

A bread-producing method which is carried out by using wheat flour to which hot water is added is used as dough (hot water kneaded dough) is known. This bread-producing method is called a method of producing the hot water kneaded dough or an alpha method.

It is known that a product produced by the method of producing the hot water kneaded dough or the alpha method has an elastic and peculiar texture. As the amount of the wheat flour which is used for the hot water kneaded dough with respect to the amount of the entire wheat flour which is used for the dough increases, texture having elasticity peculiar to the hot water kneaded dough is obtained.

A bread-producing method of adding rice flour to dough containing the wheat flour therein is known. By adding the rice flour to the dough, it is possible to obtain bread having flavor, glutinousness, and texture peculiar to the rice flour.

But it is not easy to produce bread by carrying out both bread-producing methods at the same time. That is, in producing the bread by using the method of producing the hot water kneaded dough, when hot water is added to the dough containing the wheat flour therein, gluten in the wheat flour is modified by the hot water. Consequently a caving phenomenon in which bread gets out of shape after the dough is baked is liable to occur. In the dough containing the rice flour therein, the rice flour inhibits the formation of the gluten. Therefore carbon dioxide generated by the fermentation of the dough is not held in the dough. Consequently a caving phenomenon in which bread gets out of shape after the dough is baked is liable to occur to a high extent

Because of the above-described reason, it is not easy to produce bread which has texture with elasticity peculiar to the hot water kneaded dough, the flavor and texture peculiar to the rice flour, and is entirely homogeneous.

The present invention has been made to solve the above-described problems. Therefore it is an object of the present invention to provide a method of producing bread which has texture with elasticity peculiar to the hot water kneaded dough, the flavor peculiar to the rice flour, and is entirely homogeneous.

### SUMMARY OF THE INVENTION

The above-described object is achieved by a method of producing bread described below.

A method of producing bread comprises the steps of: preparing an intermediate dough material comprising wheat flour, 0.1 to 20 parts by weight of rice flour to 100 parts by weight of said wheat flour, salt and free of skimmed powdered milk, adding 80 to 120 parts by weight of hot water to 100 parts by weight of said wheat flour to said intermediate dough material, kneading said intermediate dough material added said hot water, cooling an intermediate dough prepared by kneading until an internal temperature thereof becomes −5 degree C. to 10 degree C. and storing said intermediate dough for 24 to 72 hours with said internal temperature thereof kept in said temperature region; and adjusting a temperature of said intermediate dough cooled in said cooling/storing step to 13 degree C. to 30 degree C., wherein said intermediate dough whose temperature is adjusted to said temperature range in said temperature-adjusting step is utilized as a part of an end dough of said bread.

### DETAILED DESCRIPTION OF THE PREFERRED EMBODIMENTS

The bread-producing method of the present invention is described below.

The method of the present invention of producing bread includes a step of preparing an intermediate dough material comprising wheat flour, 0.1 to 20 parts by weight of rice flour to 100 parts by weight of the wheat flour, salt and free of skimmed powdered milk, a step of adding 80 to 120 parts by weight of hot water to 100 parts by weight of the wheat flour to the intermediate dough material, a step of kneading the intermediate dough material added the hot water, a step of cooling an intermediate dough prepared by kneading until an internal temperature thereof becomes −5 degree C. to 10 degree C. and storing the intermediate dough for 24 to 72 hours with the internal temperature thereof kept in the temperature region; and a step of adjusting a temperature of the intermediate dough cooled in the cooling/storing step to 13 degree C. to 30 degree C., and wherein the intermediate dough whose temperature is adjusted to the temperature range in the temperature-adjusting step is utilized as a part of an end dough of the bread.

In other words, the method of the present invention of producing bread includes the steps of kneading 100 parts by weight of wheat flour, 0.1 to 20 parts by weight of rice flour added to the wheat flour to which skimmed powdered milk is not added, and salt added to the wheat flour with 80 to 120 parts by weight of hot water added to 100 parts by weight of the wheat flour; cooling a prepared intermediate dough until an internal temperature thereof becomes −5 degree C. to 10 degree C. and storing the intermediate dough for 24 to 72 hours with the internal temperature thereof kept in the temperature region, and adjusting a temperature of the intermediate dough cooled in the cooling/storing step to 13 degree C. to 30 degree C. In the method of producing the bread, the intermediate dough whose temperature is adjusted to the above-described temperature range in the temperature-adjusting step is utilized as a part of the dough of the bread.

The bread-producing method of the present invention is characterized in that the intermediate dough (in other words, hot water kneaded dough) prepared in the above-described manner is utilized as a part of the end dough.

The wheat flour, the rice flour, the salt, and the hot water are used to prepare the intermediate dough.

As the wheat and salt, known wheat and salt are used.

By utilizing the intermediate dough containing the rice flour, it is possible to produce delicious breads having flavor, deliciousness, and texture peculiar to the rice flour. As the rice flour, although glutinous rice flour may be used, it is preferable to use rice flour made from non-glutinous rice. Texture produced by adding the non-glutinous rice flour to the wheat flour is more delicious and has better texture than the texture produced by adding the glutinous rice flour to the wheat flour. As the rice flour, it is possible to use both rice flour of a beta type made from rice and the rice flour of the alpha type made by heating rice to impaste it. But the rice flour of the beta type is more favorable than the rice flour of the alpha type because the former disperses into the dough more favorably than the latter and provides more favorable texture than the latter. Both the rice flour of the alpha type and that of the beta type may be added to the wheat flour.

It is preferable to use hot water having not less than 90 degree C.

In the initial step, an intermediate dough material is prepared. The intermediate dough material comprises wheat flour, 0.1 to 20 parts by weight of rice flour to 100 parts by weight of said wheat flour, salt and free of skimmed powdered milk. The intermediate dough material does not contain skimmed powdered milk or the like. In this step, the wheat flour, the rice flour, and the salt are mixed with one another.

In the present invention, at the step of preparing the components (in other words, the intermediate dough material), the skimmed powdered milk or the like is not added to the components (the intermediate dough material). To improve the flavor of the produced bread, in conventional bread-producing methods, the skimmed powdered milk is added to the wheat flour. The addition of the hot water to the wheat flour modifies the protein component in the skimmed powdered milk, thus deteriorating the flavor of the obtained bread. In consideration of this, in the bread-producing method of the present invention, the skimmed powdered milk is not added to the wheat flour. The rice flour added to the wheat flour has an effect of sufficiently improving the flavor of the produced bread.

It is necessary that the intermediate dough material includes 0.1 to 20 parts by weight of the rice flour to 100 parts by weight of the wheat flour in the intermediate dough material. It is especially favorable to include 0.2 to 10 parts by weight of the rice flour to 100 parts by weight of the wheat flour in the intermediate dough material. It is favorable that the intermediate dough material includes 4 to 15 parts by weight of the salt to 100 parts by weight of the wheat flour in the intermediate dough material and especially favorable to include 5 to 12 parts by weight of the salt to 100 parts by weight of the wheat flour in the intermediate dough material. The addition amount of the salt in the dough preparation method adopted in the present invention is considerably larger than the addition amount thereof in ordinary dough preparation methods. It is possible to restrain the propagation of bacteria in the intermediate dough by increasing the addition amount of the salt, namely, by increasing the concentration of the salt content in preparing the intermediate dough by kneading the mixture of the wheat flour, the rice flour, and the salt with the hot water. By making the concentration of the salt content high and not adding the skimmed powdered milk to the wheat flour, it is possible to restrain the propagation of bacteria to a high extent while the intermediate dough is being prepared. Regarding the amount of the salt to be added to the wheat flour, instead of adding the total amount of the salt to the end dough, the total amount of the salt may be added to the intermediate dough.

Next, a step of adding hot water is carried out At the step of adding hot water, the hot water is added to the intermediate dough material.

The addition amount of the hot water is 80 to 120 parts by weight, favorably 90 to 110 parts by weight and more favorably 90 to 100 parts by weight of 100 parts by weight of the wheat flour in the intermediate dough material. The hot water means water having a temperature not less than 85 degree C. and favorably not less than 90 degree C. or more than 97 degree C. The hot water having a temperature not less than 85 degree C. securely allows the hot water kneaded dough to display its effect. The hot water having a temperature not more than 97 degree C. does not cause the dough to have an unexpected thermal change.

Next, a step of kneading the intermediate dough material added the hot water is carried out In this step, a intermediate dough is prepared.

At this step of kneading the components of the intermediate dough with the hot water, after the wheat flour, the rice flour, and the salt are mixed with one another, the hot water is added to the mixture, and thereafter the mixture is kneaded to prepare the intermediate dough.

In this kneading step (in other words, the step of preparing the intermediate dough), it is favorable to adjust the temperature of the kneading components (in other words, the dough) to 55 degree C. to 80 degree C. The temperature of the kneading components (the dough) means the internal temperature thereof. Normally, the temperature of the kneading components (the dough) means the temperature of the central portion thereof. The temperature of the kneading components (the dough) is adjusted to more favorably 57 degree C. to 70 degree C.

Thereafter the cooling/storing step of storing the intermediate dough prepared in the above-described manner by cooling it is performed.

In the cooling/storing step, the prepared intermediate dough is cooled until its internal temperature becomes −5 degree C. to 10 degree C. and is stored for 24 to 72 hours with the internal temperature thereof kept in the above-described temperature region. In the cooling/storing step, the intermediate dough is stored in a refrigerating chamber adjusted to not more than 0 degree C. By storing the prepared intermediate dough for 24 to 72 hours with the internal temperature thereof being cooled in the range of −5 degree C. to 10 degree C., it is possible to obtain bread having a favorable texture, even though the amount of the intermediate dough (amount of hot water kneaded dough) is comparatively small.

By storing the intermediate dough for not less than 24 hours with the intermediate dough being cooled in the above-described state, it is possible to obtain bread having a favorable texture after a baking step is carried out. When the intermediate dough is stored for not more than 72 hours with the intermediate dough being cooled in the above-described state, dehydration does not occur in the dough. It is preferable to store the intermediate dough for 15 to 40 hours in the refrigerating chamber.

Thereafter a temperature-adjusting step of adjusting the temperature of the intermediate dough stored in the refrigerating chamber to 13 degree C. to 30 degree C. is performed. The temperature-adjusting step is a so-called temperature-restoring step. By restoring the temperature of the intermediate dough to a normal temperature, it is possible to favorably knead the intermediate dough with other components of the dough and homogenize the inside of baked bread. Thereby the bread provides a favorable texture. In the temperature-adjusting step, it is preferable to adjust the temperature of the intermediate dough stored in the refrigerating chamber to 15 degree C. to 2 degree C. By setting the temperature at the temperature-restoring step to a temperature higher to some extent than the cooling temperature and lower than a normal temperature, it is possible to decrease the use amount of a refrigerant small at a kneading step to be performed later.

It is, preferable that at the temperature-adjusting step, the intermediate dough stored in the refrigerator is stored in a heating cabinet for a predetermined period of time. It is preferable to set the temperature of the heating cabinet to 15 degree C. to 30 degree C. The temperature-adjusting step may be performed by taking out the intermediate dough from the refrigerator at the cooling/storing step and placing it in a normal temperature atmosphere.

In the present invention, bread is produced by utilizing the intermediate dough (hot water kneaded dough) prepared in the above-described manner as a part of the end dough. The bread-producing method of the present invention is applicable to produce any kind of bread. The bread-producing method of the present invention displays its effect very favorably by using it to produce a loaf of bread, a roll, a bun, and the like.

Any bread-producing method can be used, provided that the intermediate dough prepared in the above-described manner is used as a part of the end dough. For example, a so-called straight method (direct kneading method) and a so-called using other kneaded dough method are used. In producing bread, a remaining amount of the wheat flour necessary for preparing the entire dough (end dough), water, yeast, sugar, butter or margarine, salt, and dough prepared separately in advance are added to the intermediate dough prepared in the above-described manner, and the mixture is kneaded to prepare end dough. Thereafter the prepared end dough is fermented and baked by using an ordinary method to produce bread.

In applying the bread-producing method of the present invention to a bread-producing method which is carried out by using the direct kneading method (straight method), it is favorable to use the intermediate dough consisting of 10 to 60 parts by weight of 100 parts by weight of the wheat flour necessary for forming the total amount of the dough (end dough). It is more favorable to use the intermediate dough consisting of 20 to 50 parts by weight of 100 parts by weight of the wheat flour necessary for forming the total amount of the dough (end dough).

In the direct kneading method, the following steps are carried out: a dough preparation step (main kneading step) of kneading the intermediate dough consisting of 10 to 60 parts by weight of 100 parts by weight of the wheat flour necessary for forming the total amount of the end dough, wheat flour consisting of 40 to 90 parts by weight of 100 parts by weight of the wheat flour necessary for forming the total amount of the end dough, sugar, yeast, butter or margarine, and water; a fermenting step of fermenting a prepared dough, and a baking step of baking a fermented dough.

The fermenting step is performed by using an ordinary method. Normally in the fermenting step, after end dough is left (floor), it is divided and rolled. After the end dough is left again (bench), final fermentation (drier) is carried out Thereafter the end dough is baked by using an ordinary method.

In applying the bread-producing method of the present invention to a bread-producing method which is carried out by the using other kneaded dough method, it is preferable to use the intermediate dough consisting of 10 to 30 parts by weight of 100 parts by weight of the wheat flour necessary for forming the total amount of the dough (end dough).

In the using other kneaded dough method, the following steps are carried out a fermented other kneaded dough-preparing step of kneading the wheat flour, the yeast, and the water to form an other kneaded dough and fermenting the other kneaded dough; an end dough preparation step of kneading wheat flour consisting of 5 to 20 parts by weight of 100 parts by weight of the wheat flour necessary for forming the total amount of the end dough, the intermediate dough consisting of 10 to 30 parts by weight of 100 parts by weight of the wheat flour necessary for forming the total amount of the end dough, the fermented other kneaded dough consisting of 40 to 80 parts by weight of 100 parts by weight of the wheat flour necessary for forming the total amount of the end dough, the sugar, the butter or the margarine, and the water; a fermenting step of fermenting the prepared end dough; and a baking step of baking the fermented dough (end dough).

In this method, the fermented other kneaded dough is prepared. The fermented other kneaded dough is prepared by kneading the wheat flour, the yeast, and the water to form the other dough and thereafter fermenting the other dough by using the ordinary method. Thereafter the intermediate dough (hot water kneaded dough), the fermented other kneaded dough, the wheat flour, the sugar, the butter or the margarine, and the water are kneaded to prepare the end dough. Thereafter the prepared end dough is fermented by using an ordinary method. Normally in the fermenting step, after the end dough is left (floor), it is divided and rolled. After the end dough is left again (bench), final fermentation (drier) is carried out. Thereafter the end dough is baked by using an ordinary method.

In the present invention, after hot water is added to the material containing the rice flour to knead the components of the material, the hot water kneaded dough stored in the refrigerator is used. Therefore bread produced by the bread-producing method of the present invention is allowed to have peculiar flavor and texture and a favorable baked state. Further the bread produced by the bread-producing method has texture having elasticity and keeps a favorable hydrated state for a certain period of time.

### EXAMPLES

Examples of the present invention are described below.

### Example 1

In the example 1, the bread-producing method of the present invention is applied to the straight method (direct kneading method).

The rice flour of the beta type made from the non-glutinous rice was added to the intermediate dough. Bread was produced by carrying out the step of kneading the components of the intermediate dough with the hot water, the cooling/storing step, the temperature-adjusting step, the main kneading step, the fermenting step, and the baking step in a manner described below.

Step of Kneading Components of Intermediate Dough with Hot Water

Components of the intermediate dough were mixed with one another in a manner as described below by using an ordinary method to prepare the intermediate dough of the example 1. The amount of each component used is shown below. A low speed, a middle speed, and a high speed used in mixing the components of the intermediate dough mean 90 rpm, 180 rpm, and 270 rpm respectively, which applies to other examples.

### Components Used and Amounts Thereof

Wheat flour: 2000 g (20 parts by weight of 100 parts by weight of wheat flour necessary for forming end dough)
Salt: 200 g
Rice flour: 10 g (0.1% of total amount of wheat flour necessary for forming end dough, 0.5 parts by weight of 100 parts by weight of wheat flour necessary for forming intermediate dough)

After the above-described components were mixed with one another, 2000 g of hot water (95 degree C.) was supplied to the mixture of the components. Thereafter the components were kneaded for three minutes at the low speed and then two minutes at the middle speed to prepare the intermediate dough (hot water kneaded dough). The internal temperature (kneading temperature) of the prepared hot water kneaded dough was 65 degree C.

### Cooling/Storing Step

Thereafter the obtained intermediate dough (hot water kneaded dough) was left in a refrigerator at −1 degree C. to cool it for 35 hours. After an elapse of four hours, it was confirmed that the internal temperature of the intermediate dough became not more than 20 degree C. The internal temperature of the intermediate dough became about 8 degree C. after the intermediate dough was left in the refrigerator for 40 hours. This indicates that the intermediate dough was left in the refrigerator in the temperature range of 5 degree C. to 15 degree C. for about 32 hours.

### Temperature-Adjusting Step

The intermediate dough (hot water kneaded dough) left in the refrigerator was stored for two hours in a heating cabinet adjusted to 25 degree C. The internal temperature of the intermediate dough taken out of the heating cabinet was 20 degree C.

### Main Kneading Step

End dough was prepared as described below from the intermediate dough whose temperature was adjusted in a manner described above.
Wheat flour: 8000 g
Sugar: 500 g
Yeast: 300 g
Margarine: 500 g
Intermediate dough (hot water kneaded dough): Total amount of the prepared intermediate dough (amount of wheat flour: 2000 g, amount of rice flour: 200 g)
Water: 5000 g

Except the margarine, after the above-described components were kneaded for four minutes at the low speed and eight minutes at the middle speed, the total amount of the margarine was supplied to the mixture. Thereafter the components were kneaded for three minutes at the low speed and five minutes at the middle speed to prepare the total-amount dough (end dough). The internal temperature (kneading temperature) of the prepared total-amount dough (end dough) was 27 degree C.

### Fermenting and Baking Steps

Thereafter the total-amount dough (end dough) was fermented and baked by using an ordinary method to produce a loaf of bread.

The end dough was ripened for 60 minutes (floor time). After the end dough was divided into a plurality of pieces, they were ripened for 15 minutes (bench time). After the divided pieces were put into a drier (fermenting appliance) to ferment them for 60 minutes. After a lid was placed on a die for shaping the dough into a loaf of bread with the divided pieces placed therein, they were put into a baking oven to bake them at 200 degree C./200 degree C. (upper-side and lower-side temperatures, 45 minutes). In this manner, rectangular solid-shaped bread was produced.

### Example 2

Except that the addition amount of the rice flour at the step of kneading the components of the intermediate dough with the hot water was changed to 50 g (0.5% of wheat flour for forming end dough, 2.5 parts by weight of 100 parts by weight of wheat flour for forming intermediate dough), rectangular solid-shaped bread was produced in the same manner as that of the example 1.

### Example 3

Except that the addition amount of the rice flour at the step of kneading the components of the intermediate dough with the hot water was changed to 100 g (1% of wheat flour for forming end dough, 5 parts by weight of 100 parts by weight of wheat flour for forming intermediate dough), rectangular solid-shaped bread was produced in the same manner as that of the example 1.

### Example 4

Except that the addition amount of the rice flour at the step of kneading the components of the intermediate dough with the hot water was changed to 400 g (4% of wheat flour for forming end dough, 20 parts by weight of 100 parts by weight of wheat flour for forming intermediate dough), rectangular solid-shaped bread was produced in the same manner as that of the example 1.

### Example 5

Except that the addition amount of the rice flour at the step of kneading the components of the intermediate dough with the hot water was changed to 5 g (0.05% of wheat flour for forming end dough, 0.25 parts by weight of 100 parts by weight of wheat flour for forming intermediate dough), rectangular solid-shaped bread was produced in the same manner as that of the example 1.

### Comparison Example 1

Except that the rice flour was not added to the wheat flour at the step of kneading the components of the intermediate dough with the hot water, rectangular solid-shaped bread was produced in the same manner as that of the example 1.

### Comparison Example 2

Except that the temperature-adjusting step was not carried out at the step of kneading the components of the intermediate dough with the hot water, rectangular solid-shaped bread was produced in the same manner as that of the example 1. In the comparison example 2, a preferable main kneading step was not performed.

### Example 6

Except that the rice flour of the beta type made from the non-glutinous rice was used at the step of kneading the components of the intermediate dough with the hot water and that the addition amount of the rice flour was changed to 50 g (0.5% of wheat flour for forming end dough, 2.5 parts by weight of 100 parts by weight of wheat flour for forming intermediate dough), rectangular solid-shaped bread was produced in the same manner as that of the example 1.

### Example 7

Except that the rice flour of the alpha type made from the glutinous rice was used at the step of kneading the components of the intermediate dough with the hot water and that the addition amount of the rice flour was changed to 50 g (0.5% of wheat flour for forming end dough, 2.5 parts by weight of 100 parts by weight of wheat flour for forming intermediate dough), rectangular solid-shaped bread was produced in the same manner as that of the example 1.

### Example 8

In the example 8, the bread-producing method of the present invention was applied to the other kneaded dough method.

The rice flour of the beta type made from the non-glutinous rice was added to the intermediate dough. Rectangular solid-shaped bread was produced by carrying out the step of kneading the components of the intermediate dough with the hot water, the cooling/storing step, the temperature-adjusting step, the fermented other kneaded dough-preparing step, the main kneading step, the fermenting step, and the baking step in a manner described below.

Step of Kneading Components of Intermediate Dough with Hot Water

Components of the intermediate dough were mixed with one another in a manner as described below by using an ordinary method to prepare the intermediate dough of the example 8. The amount of each component used is shown below. A low speed, a middle speed, and a high speed used in mixing the components of the intermediate dough mean 90 rpm, 180 rpm, and 270 rpm respectively, which applies to other examples.

### Components Used and Amounts Thereof

Wheat flour: 2000 g (20 parts by weight of 100 parts by weight of wheat flour necessary for forming end dough)
Salt: 200 g
Rice flour: 10 g (0.1% of wheat flour of total amount of wheat flour necessary for forming end dough, 0.5 parts by weight of 100 parts by weight of wheat flour necessary for forming intermediate dough)

After the above-described components were mixed with one another, 2000 g of hot water (95 degree C.) was supplied to the mixture of the components. Thereafter the components were kneaded for three minutes at the low speed and then two minutes at the middle speed to prepare the intermediate dough (hot water kneaded dough). The internal temperature (kneading temperature) of the prepared hot water kneaded dough was 65 degree C.

### Cooling/Storing Step

Thereafter the obtained intermediate dough (hot water kneaded dough) was left in a refrigerator at −1 degree C. to cool it for 35 hours. After an elapse of four hours, it was confirmed that the internal temperature of the intermediate dough became not more than 3 degree C. The internal temperature of the intermediate dough became about 0 degree C. after the intermediate dough was left in the refrigerator for 40 hours. This indicates that the intermediate dough was left in the refrigerator in the temperature range of 3 degree C. to 0 degree C. for about 32 hours.

### Temperature-Adjusting Step

The intermediate dough (hot water kneaded dough) left in the refrigerator was stored for two hours in a heating cabinet adjusted to 30 degree C. The internal temperature of the intermediate dough taken out of the heating cabinet was 27 degree C.

### Fermented Other Kneaded Dough-Preparing Step

The fermented other kneaded dough-preparing step was carried out with the step of kneading the components of the intermediate dough with the hot water being carried out.
Wheat flour: 7000 g
Yeast 300 g
Water: 3500 g

After the above-described components were mixed with one another, the components were kneaded for two minutes at the low speed and then two minutes at the middle speed. The kneading temperature was set to 24 degree C. The mixture was fermented inside a heating cabinet (fermenting appliance) adjusted to 27 degree C. for four hours to prepare fermented other kneaded dough.

### Main Kneading Step

A end dough was prepared in a manner described below from the intermediate dough (hot water kneaded dough) and the fermented other kneaded dough having the temperature thereof adjusted as described above respectively.
Wheat flour: 1000 g
Sugar: 300 g
Margarine: 500 g
Water: 1000 g
Intermediate dough: Total amount of the prepared intermediate dough (amount of wheat flour: 2000 g, amount of rice flour: 200 g)
Other kneaded dough: Total amount of the prepared fermented other kneaded dough (amount of wheat flour: 7000 g)

Except the margarine, after the above-described components were mixed with one another and kneaded for two minutes at the low speed and four minutes at the middle speed, the total amount of the margarine was supplied to the mixture. Thereafter the components were further kneaded for two minutes at the low speed and five minutes at the middle speed to prepare the total-amount dough (end dough). The internal temperature (kneading temperature) of the prepared total-amount dough (end dough) was 27 degree C.

### Fermenting and Baking Steps

Thereafter the total-amount dough (end dough) was fermented and baked by using an ordinary method to produce a loaf of bread.

The end dough was ripened for 60 minutes (floor time). After the end dough was divided into a plurality of pieces, they were ripened for 15 minutes (bench time). After the divided pieces were put into a drier to ferment them for 60 minutes. After a lid was placed on a die for shaping the dough into a loaf of bread with the divided pieces placed therein, they were put into a baking oven to bake them at 200 degree C./200 degree C. (upper-side and lower-side temperatures, 45 minutes). In this manner, rectangular solid-shaped bread was produced.

### Example 9

Except that the addition amount of the rice flour at the step of kneading the components of the intermediate dough with the hot water was changed to 50 g (0.5% of wheat flour for forming end dough, 2.5 parts by weight of 100 parts by weight of wheat flour for forming intermediate dough), rectangular solid-shaped bread was produced in the same manner as that of the example 8.

### Example 10

Except that the addition amount of the rice flour at the step of kneading the components of the intermediate dough with the hot water was changed to 100 g (1% of wheat flour for forming end dough, 5 parts by weight of 100 parts by weight of wheat flour for forming intermediate dough), rectangular solid-shaped bread was produced in the same manner as that of the example 8.

### Example 11

Except that the addition amount of the rice flour at the step of kneading the components of the intermediate dough with the hot water was changed to 400 g (4% of wheat flour for forming end dough, 20 parts by weight of 100 parts by weight of wheat flour for forming intermediate dough), rectangular solid-shaped bread was produced in the same manner as that of the example 8.

### Example 12

Except that the addition amount of the rice flour at the step of kneading the components of the intermediate dough with the hot water was changed to 5 g (0.05% of wheat flour for forming end dough, 0.25 parts by weight of 100 parts by weight of wheat flour for forming intermediate dough), rectangular solid-shaped bread was produced in the same manner as that of the example 8.

### Example 13

Except that the rice flour of the beta type made from the non-glutinous rice was used at the step of kneading the components of the intermediate dough with the hot water and that the addition amount of the rice flour was changed to 50 g (0.5% of wheat flour for forming end dough, 2.5 parts by weight of 100 parts by weight of wheat flour for forming intermediate dough), rectangular solid-shaped bread was produced in the same manner as that of the example 8.

### Example 14

Except that the rice flour of the alpha type made from the glutinous rice was used at the step of kneading the components of the intermediate dough with the hot water and that the addition amount of the rice flour was changed to 50 g (0.5% of wheat flour for forming end dough, 2.5 parts by weight of 100 parts by weight of wheat flour for forming intermediate dough), rectangular solid-shaped bread was produced in the same manner as that of the example 8.

### Comparison Example 3

Except that the rice flour was not added to the wheat flour at the step of kneading the components of the intermediate dough with the hot water, rectangular solid-shaped bread was produced in the same manner as that of the example 8.

### Comparison Example 4

Except that the temperature-adjusting step was not carried out at the step of kneading the components of the intermediate dough with the hot water, rectangular solid-shaped bread was produced in the same manner as that of the example 8. In the comparison example 4, a preferable main kneading step was not performed.

### Quality Evaluation Test

The quality and preference for the obtained rectangular solid-shaped bread of the examples 1 through 14 and the comparison examples 1 through 4 were examined.

The examined items were the film extension of the internal phase of the loaf of bread, the hardness degree of the crumb of the loaf of bread, the desirableness degree of taste, the desirableness degree of smell, and the desirableness degree of texture.

The results of the test are shown in tables 1 through 4.

To check the internal phase of the loaf of bread, the state of the film extension of the internal phase thereof was visually checked. The “film extension” means a state in which at an initial stage of baking of the dough, vertical lines appear in the internal phase of the loaf of bread as a result of the extension of the elastic dough owing to the presence of carbon dioxide and alcohol contained in the dough. A favorable “film extension” means that favorable vertical lines are formed in the internal phase. In this case, the loaf of bread can be evaluated highly in its quality. An unfavorable “film extension” means that favorable vertical lines are not formed on the internal phase. In this case, the loaf of bread cannot be evaluated highly in its quality.

The hardness of the crumb (internal phase) of the loaf of bread was measured by using a texture analyzer having a plunger whose diameter is 20 mm. The hardness of the crumb is measured by storing the loaf of bread indoors at a temperature of 20 degree C. The hardness of the crumb was measured on the first day, the second day, and the third day after the loaf of bread was produced. The hardness of the crumb is used as an index of the phenomenon of aging of the loaf of bread. As the hardness of the loaf of bread becomes lower, the produced loaf of bread is increasingly elastic and soft. Therefore when the crumb of the loaf of bread has a low hardness, it can be evaluated highly in its quality.

Three elements indicating the desirableness degree, namely, the desirableness degree of taste, the desirableness degree of smell, and the desirableness degree of texture were evaluated by 20 skilled panelists on the basis of 10 points. The average value of the data on each item provided by 20 panelists is shown in the tables. The higher the point is, the better the preference for the loaf of bread is.

TABLE 1

| | | Example 1 | Example 2 | Example 3 | Example 4 | Example 5 |
|---|---|---|---|---|---|---|
| Amount of rice flour of total | | 0.1% | 0.5% | 1.0% | 4.0% | 0.05% |
| amount of wheat flour | | | | | | |
| Amount of rice flour of | | 0.5 parts | 2.5 parts | 5 parts by | 20 parts | 0.25 parts |
| amount of wheat flour | | by weight | by weight | weight | by weight | by weight |
| contained in intermediate | | | | | | |
| dough | | | | | | |
| Internal phase of bread | | Preferably | Preferably | A little | Thick | Preferably |
| | | extensible | extensible | thick | | extensible |
| Hardness | First day | 193 | 195 | 201 | 210 | 194 |
| of crumb | Second day | 290 | 295 | 301 | 312 | 293 |
| of loaf of | Third day | 329 | 336 | 338 | 342 | 330 |
| bread | | | | | | |
| [g] | | | | | | |
| Evaluation | Desirableness | 8.2 | 8.3 | 7.9 | 7.5 | 7.9 |
| of | degree of taste | | | | | |
| preference | Desirableness | 8.3 | 8.4 | 7.9 | 7.6 | 7.8 |
| | degree of smell | | | | | |
| | Desirableness | 8.5 | 8.5 | 8.1 | 7.8 | 8.1 |
| | degree of | | | | | |
| | texture | | | | | |

TABLE 2

| | | | | | Com- |
|---|---|---|---|---|---|
| | | | | | par- |
| | | | | Compar- | ison |
| | | | | ison | Exam- |
| | | Example 6 | Example 7 | Example 1 | ple 2 |
| Amount of rice flour | | 0.5% | 0.5% | 0% | 0.1% |
| of total amount of | | | | | |
| wheat flour | | | | | |
| Amount of rice flour of | | 2.5 parts | 2.5 parts | 0 | 0.5 |
| amount of wheat flour | | by weight | by weight | | parts |
| contained in intermediate | | | | | by |
| dough | | | | | weight |
| Internal phase of bread | | Preferably | Preferably | Preferably | Thick |
| | | extensible | extensible | extensible | |
| Hardness | First day | 196 | 198 | 191 | 212 |
| of crumb | Second day | 294 | 298 | 291 | 305 |
| of loaf of | Third day | 335 | 334 | 330 | 343 |
| bread | | | | | |
| [g] | | | | | |
| Evaluation | Desirableness | 8.3 | 8.2 | 7.5 | 6.8 |
| of | degree of taste | | | | |
| preference | Desirableness | 8.4 | 8.1 | 7.8 | 6.6 |
| | degree of smell | | | | |
| | Desirableness | 8.8 | 8.1 | 7.8 | 6.2 |
| | degree of | | | | |
| | texture | | | | |

TABLE 3

| | | | | Example | Example | Example |
|---|---|---|---|---|---|---|
| | | Example 8 | Example 9 | 10 | 11 | 12 |
| Amount of rice flour of total | | 0.1% | 0.5% | 1.0% | 4.0% | 0.05% |
| amount of wheat flour | | | | | | |
| Amount of rice flour of | | 0.5 parts | 2.5 parts | 5 parts by | 20 parts | 0.25 parts |
| amount of wheat flour | | by weight | by weight | weight | by weight | by weight |
| contained in intermediate | | | | | | |
| dough | | | | | | |
| Internal phase of bread | | Preferably | Preferably | A little | Thick | Preferably |
| | | extensible | extensible | thick | | extensible |
| Hardness | First day | 206 | 208 | 212 | 223 | 206 |
| of crumb | Second day | 293 | 295 | 300 | 315 | 295 |
| of loaf of | Third day | 315 | 320 | 330 | 333 | 321 |
| bread | | | | | | |
| [g] | | | | | | |
| Evaluation | Desirableness | 8.3 | 8.5 | 7.9 | 7.3 | 7.8 |
| of | degree of taste | | | | | |
| preference | Desirableness | 8.5 | 8.5 | 7.9 | 7.5 | 7.6 |
| | degree of smell | | | | | |
| | Desirableness | 8.7 | 8.7 | 8.1 | 7.8 | 8.2 |
| | degree of | | | | | |
| | texture | | | | | |

TABLE 4

| | | | | | Com- |
|---|---|---|---|---|---|
| | | | | | par- |
| | | | | Compar- | ison |
| | | Example | Example | ison | Exam- |
| | | 13 | 14 | Example 3 | ple 4 |
| Amount of rice flour of | | 0.5% | 0.5% | 0% | 0.1% |
| total amount of | | | | | |
| wheat flour | | | | | |
| Amount of rice flour of | | 2.5 parts | 2.5 parts | 0 | 0.5 |
| amount of wheat flour | | by weight | by weight | | parts |
| contained in intermediate | | | | | by |
| dough | | | | | weight |
| Internal phase of bread | | Preferably | Preferably | Preferably | Thick |
| | | extensible | extensible | extensible | |
| Hardness | First day | 210 | 205 | 208 | 225 |
| of crumb | Second day | 296 | 296 | 297 | 320 |
| of loaf of | Third day | 318 | 322 | 321 | 341 |
| bread | | | | | |
| [g] | | | | | |
| Evaluation | Desirableness | 8.6 | 8.3 | 7.5 | 6.8 |
| of | degree of taste | | | | |
| preference | Desirableness | 8.8 | 8.3 | 7.6 | 6.5 |
| | degree of smell | | | | |
| | Desirableness | 8.8 | 8.2 | 7.6 | 6.0 |
| | degree of | | | | |
| | texture | | | | |

As shown in Tables 1 through 3, the loaf of bread of any of the examples 1 through 8 had a quality improved over the bread of the comparison examples, because in the bread of the examples, the rice flour is added to the dough, and the temperature-adjusting step is carried out in preparing the intermediate dough. Most of the evaluated marks indicating the panelists' preference for the bread were not less than 8.0 points. On the other hand, the evaluated marks not more than 8.0 were given to any of the loaf of bread of the comparison examples 1, 3 in which the rice flour is not added to the wheat flour and the comparison examples 2, 4 in which the temperature-adjusting step is not performed.

In the bread-producing method of the present invention, the intermediate dough produced through the step of kneading the components thereof with the hot water, the cooling/storing step, and the temperature-adjusting step is utilized as a part of the dough (end dough). Therefore it is possible to produce bread that has texture with elasticity peculiar to the hot water kneaded dough, the flavor peculiar to the rice flour, and is entirely homogeneous.

What is claimed is:

1. A method of producing bread comprising the steps of:
preparing an intermediate dough material comprising wheat flour, 0.1 to 20 parts by weight of rice flour to 100 parts by weight of said wheat flour, salt and free of skimmed powdered milk,
adding 80 to 120 parts by weight of hot water to 100 parts by weight of said wheat flour to said intermediate dough material,
kneading said intermediate dough material added said hot water,
cooling an intermediate dough prepared by kneading until an internal temperature thereof becomes −5 degree C. to 10 degree C. and storing said intermediate dough for 24 to 72 hours with said internal temperature thereof kept in said temperature region; and
adjusting a temperature of said intermediate dough cooled in said cooling/storing step to 13 degree C. to 30 degree C.,
wherein said intermediate dough whose temperature is adjusted to said temperature range in said temperature-adjusting step is utilized as a part of an end dough of said bread.

2. A method of producing bread according to claim 1, wherein said intermediate dough material includes 4 to 15 parts by weight of said salt to 100 parts by weight of said wheat flour.

3. A method of producing bread according to claim 1, which is carried out by using a direct kneading method of using said intermediate dough consisting of 10 to 60 parts by weight of 100 parts by weight of said wheat flour necessary for forming a total amount of said end dough.

4. A method of producing bread according to claim 1, comprising
an end dough preparation step of kneading said intermediate dough consisting of 10 to 60 parts by weight of 100 parts by weight of wheat flour necessary for forming a total amount of said end dough, wheat flour consisting of 40 to 90 parts by weight of 100 parts by weight of wheat flour necessary for forming the total amount of said end dough, sugar, yeast, butter or margarine, and water;
a fermenting step of fermenting the end dough; and a baking step of baking the fermented end dough.

5. A method of producing bread according to claim 1, which is carried out by using other dough and said intermediate dough consisting of 10 to parts by weight of 100 parts by weight of wheat flour necessary for forming a total amount of said end dough.

6. A method of producing bread according to claim 1, comprising
a fermented other dough preparing step of kneading wheat flour, yeast, and water to form an other dough and fermenting said other dough;
an end dough preparation step of kneading said intermediate dough consisting of 10 to 30 parts by weight of 100 parts by weight of wheat flour necessary for forming a total amount of the end dough, said fermented other dough consisting of 40 to 80 parts by weight of 100 parts by weight of wheat flour necessary for forming the total amount of the end dough, wheat flour consisting of 5 to 20 parts by weight of 100 parts by weight of wheat flour necessary for forming the total amount of the end dough, sugar, butter or margarine, and water;
a fermenting step of fermenting the end dough; and
a baking step of baking the fermented end dough.

7. A method of producing bread according to claim 1, wherein said intermediate dough material added said hot water is kneaded at 55 degree C. to 80 degree C.

8. A method of producing bread according to claim 1, wherein at said temperature-adjusting step, a temperature of said intermediate dough cooled in said cooling/storing step is adjusted to 15 degree C. to 20 degree C.

9. A method of producing bread according to claim 1, wherein said rice flour is of beta type.

10. A method of producing bread according to claim 1, wherein said rice flour is non-glutinous rice flour.

11. A method of producing bread according to claim 1, wherein said bread is a loaf of bread or a roll.

12. A method of producing bread according to claim 1, wherein said rice flour is non-glutinous rice flour; and said bread is a loaf of bread or a roll.

13. A method of producing bread according to claim 1, wherein said intermediate dough material includes 4 to 15 parts by weight of said salt to 100 parts by weight of said wheat flour; said rice flour is non-glutinous rice flour; and said bread is a loaf of bread.

14. A method of producing bread according to claim 1, wherein said intermediate dough material includes 4 to 15 parts by weight of said salt to 100 parts by weight of said wheat flour; said rice flour is non-glutinous rice flour; said bread is a loaf of bread; and said method of producing said bread comprises a fermented other dough preparing step of kneading wheat flour, yeast, and water to form an other dough and fermenting said other dough; an end dough preparation step of kneading said intermediate dough consisting of 10 to 30 parts by weight of 100 parts by weight of wheat flour necessary for forming a total amount of the end dough, said fermented other dough consisting of 40 to 80 parts by weight of 100 parts by weight of wheat flour necessary for forming the total amount of the end dough, wheat flour consisting of 5 to 20 parts by weight of 100 parts by weight of wheat flour necessary for forming the total amount of the end dough, sugar, butter or margarine, and water; a fermenting step of fermenting the end dough; and a baking step of baking the fermented end dough.
